(19) United States
(12) Patent Application Publication
(10) Pub. No.: US 2024/0013687 A1
(43) Pub. Date: Jan. 11, 2024

(54) SPRING-ACTUATED MARKETING DISPLAY AND METHODS OF USE THEREOF

(71) Applicant: Balloon Innovations Inc., Westminster, CO (US)

(72) Inventors: Christopher Jon Wicken, JR., Westminster, CO (US); Alex John Fountain, Evergreen, CO (US)

(21) Appl. No.: 18/219,081

(22) Filed: Jul. 6, 2023

Related U.S. Application Data
(60) Provisional application No. 63/359,063, filed on Jul. 7, 2022.

(51) Int. Cl. G09F 15/00

(52) U.S. Cl. CPC G09F 15/0075

(57) ABSTRACT

This invention described herein relates to a novel marketing display, and in particular a marketing display apparatus configured to be secured to a base or the ground and generate lateral movement in 360° degrees.

### CROSS REFERENCES TO RELATED APPLICATION

This application claims the benefit of and priority to U.S. Provisional Application No. 63/359,063, filed Jul. 7, 2022. The entire specification and figures of the above-referenced application is hereby incorporated in its entirety by reference.

### TECHNICAL FIELD

This invention described herein relates to a novel spring-actuated marketing display apparatus, and in particular a spring-actuated marketing display having a plurality of spring assemblies that can be secured to a base and positioned in series so as to generate lateral movement in response to an external force.

### BACKGROUND

Traditional marketing displays, such as flags, banners, signs, and balloons are often placed in, or near commercial establishments to draw customer attention. In some cases, in an efforts to better attract consumer attention marketing displays are movable, for example through direct human intervention by a mechanical force generated by a machine, or a natural external force such as wind. In one traditional example, a marketing display, such as a sign is coupled with one end of a rigid metal H-stake with the opposing end being secured in the ground. These marketing display systems are easily bent in response in the wind and cannot generally be repositioned in their original form limiting their ability to be re-used. Moreover, these marketing display systems are static and cannot generate movement that would better catch the attention of a consumer or other observer.

In recent years, various inflatable external marketing devices have been deployed to attract public attention. Many of these traditional marketing devices include some type of constant or irregular motion to attract consumer attention. For example, “tube men” or “Sky Dancers®” have been presented in an attempt to address the limitations related to static Commercial marketing displays. These devices may include a long tube, in some cases having arms and/or other anthropomorphic features. The main inflatable tube may be attached to an air blower which inflates the main tube such that it is positioned in a substantially vertical position. While partially inflated by the air blower, such “tube men” may include a hole at the top of the main inflatable tube to let a pre-determined amount of air escape at any given time. In this configuration, when the main inflatable tube reaches a near vertical position, a sufficient amount of air is allowed to escape such that the weight of the inflatable tube overcomes the internal pressure from the blower and collapses in on itself. As the tube collapses, it may fold in on itself, cutting off the ability of the air to effectively escape the tube causing the build-up of internal pressure within the tube re-inflating it to a near vertical position. In this configuration, the inflatable tube will cycle between partially inflated and partially deflated positions giving the tube, and associated features, a constant irregular motion that may attract a customer's attention.

While popular, such traditional inflatable tube systems have several drawbacks. First, due to the size and length of the inflatable tube, as the tube collapses, it, and often any appendages that are attached to the tube, can scrap against the ground. This has the effect of not only prematurely wearing out the inflatable tube, but causing it to have a dirty, or dull appearance. Often users must place special mats at the base of the tube to mitigate this effect. Second, such traditional inflatable tubes cannot be effectively operated in moderate, to high wind conditions limiting their ability to be used outside during certain times of year. Third, because of the collapsible nature of the inflatable tube, it is very difficult to determine where and how the tube will collapse. As a result, traditional inflatable tubes must be placed away from where customers might be present, lest they be struck by the collapsing tube.

As can be seen, there is a need for a single comprehensive solution to the limitations of traditional systems described above. It is therefore the object of the present invention to provide a cost effective and durable spring-actuated marketing display that can be secured an external surface, and can provide a movement based marketing attractant that may operate in all weather conditions and in close proximity to consumers. Accordingly, the objects of the methods and apparatus described herein address each of the aforementioned problems and goals in a practical manner. As such, there exists a need for a simple, and reusable system to provide for a movable marketing display.

### SUMMARY OF THE INVENTION

One aspect of the present invention include systems, methods, and apparatus for a spring-actuated marketing display. In one preferred aspect, a spring-actuated marketing display may be configured to be secured to a base, the ground, or external surface and provides lateral movement in one or more directions, and preferably 360° degrees of lateral movement.

In another aspect, the invention may include a spring-actuated marketing display having a plurality of spring assemblies. In one preferred embodiment, each spring assembly may further include a spring, at least one spring mount, and a support rod secured to said spring mount. Further, in this embodiment the support rods from each assembly are coupled forming a linear series of spring assemblies that may further be secured to a base. A display cover, having one or more marketing visual or written advertising messages may be positioned over the linear series of spring assemblies. In this configuration, the marketing display provides lateral movement in one or more directions, and preferably 360° degrees of lateral movement when an external force is applied to the spring assembly.

In another aspect, the marketing display of the invention may have a spring assembly having a spring, a spring mount and a support rod secured to said spring mount. The support rod of this embodiment may be secured to a base, and a display cover positioned over the spring assembly. In this embodiment, the support rod of the invention may be made of a flexible material, such fiberglass to allow lateral movement when an external force is applied to the spring assembly.

In another embodiment, marketing display of the invention may include a plurality of support rods, each supporting a spring assembly. In one example a distal support rod, and one or more central support rods of a spring-actuated marketing display can be flexible, and the proximal support rod can be static. In this embodiment, the distal support rod, and one or more central support rods, and their associated distal and central spring assemblies can exhibit greater lateral movement at the top of the display compared to the bottom the display, where the proximal spring assembly may have less lateral movement.

In another aspect, the base of the invention may be weighted, and/or secured to the ground, or another external surface such that the lateral movement of the spring assembly can be constrained such that the marketing display does not tip over due to excessive lateral movement.

In another aspect, the invention includes a tractable marketing display having a plurality of disk supports positioned along the length of a support rod, which can further be secured to a base. In a preferred aspect, a display cover can be positioned over said plurality of disk supports forming the frame of the tractable display. In this aspect, the terminal portion of the support rod is tractable allowing the rod to move laterally, while the proximal portion of the support rod is static inhibiting lateral movement of the rod.

Further objects of the inventive technology will become apparent from the description and drawings below.

### BRIEF DESCRIPTION OF THE FIGURES

FIG. 1: shows an isolated spring-actuated marketing display having a distal, central and proximal spring assembly secured in series and further supported by a series of coupled support rods secured to a base in one embodiment thereof;

FIG. 2A-C: (A) shows an isolated spring-actuated marketing display having a distal, central and proximal spring assembly secured in series and further supported by a series of coupled support rods secured to a base, and the same spring-actuated marketing display having an exemplary display over positioned over the display in one embodiment thereof; (B) spring-actuated marketing display having an transparent display cover positioned over the display in one embodiment thereof; and (C) shows exemplary lateral movement of an isolated spring-actuated marketing display in one embodiment thereof; and

FIG. 3: shows a disassociated display cover showing an exemplary display section in one embodiment thereof.

FIG. 4: shows an isolated tractable marketing display having a plurality of disk supports positioned along a support rod in one embodiment thereof.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

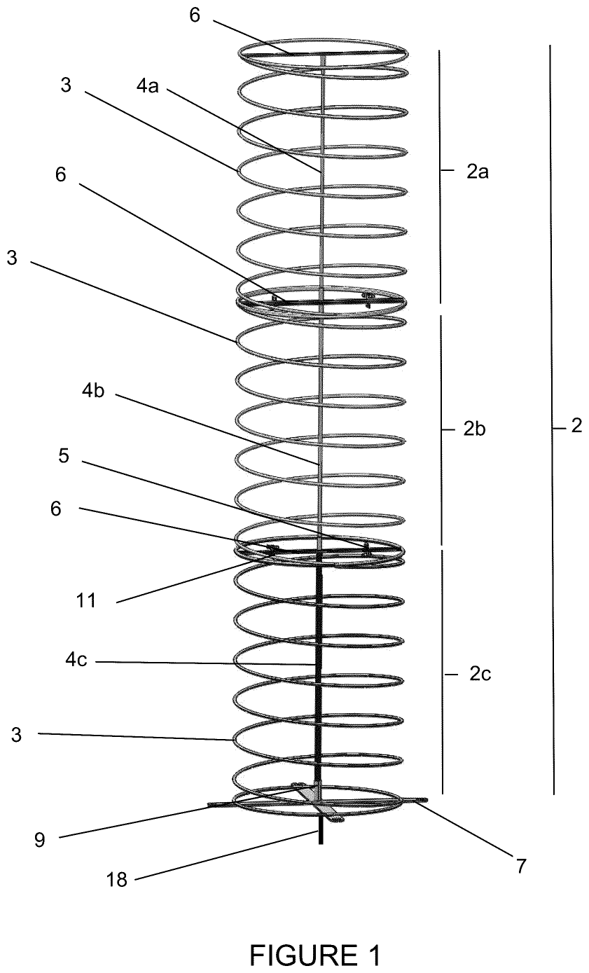

The present invention includes a spring-actuated marketing display (1) that can exhibit lateral movement when an external force is applied to one or more spring assemblies (2). A spring assembly (2) of the invention may include a spring (3) coupled with one or more spring mounts (6) and a support rod (4). In a preferred embodiment a plurality of spring assemblies (2) of the invention may be coupled together forming a linear series of spring assemblies (2). In the configuration shown in FIG. 1, the spring-actuated marketing display (1) of the invention may include a distal spring assembly (2a), a central spring assembly (2b), and a proximal spring assembly (2c) coupled in series forming a modular spring assembly (2) unit.

The individual spring assemblies (2a, b, c) of the invention can be coupled together in series through a plurality of corresponding spring mounts (6). As shown in FIG. 1, in a preferred embodiment a spring mount (6) of the invention may include a support beam that can be positioned internally within the body of the spring (3) and secured to the outer coil elements of the spring (3). In this configuration, the spring mount (6) can provide a buttressing force to stabilize the spring and prevent distortions from being introduced during lateral movement of the spring assembly (2). The spring mount (6) can be place anywhere along the body of the spring (3), but may preferably be positioned along the top and bottom portions of the spring assembly (2).

Again, as shown in FIG. 1, in this embodiment the spring mount (6) of a spring assembly (2) can be coupled with the spring mount (6) of an adjacent spring assembly thereby forming a linear configuration. Adjacent spring mounts (6) can be coupled together through one or more fasteners (11), or in alternative embodiments may be coupled through one or more separable, or integral couplers, such as a fitted coupler, a pin coupler, a twist coupler, a snap coupler, a quick release coupler, a slide coupler, a latch coupler, and a lock coupler.

In further embodiments, a spring mount (6) of the invention can be configured to include an aperture (not shown) through which a support rod (4) can be inserted. In the preferred embodiment shown in FIG. 1, each spring assembly (2) may include a corresponding support rod (4) that can further be secured in series through a coupler assembly (5). A coupler assembly (5) of the invention may be selected from the group consisting of: a fitted coupler, a pin coupler, a twist coupler, a snap coupler, a quick release coupler, a slide coupler, a latch coupler, and a lock coupler.

Again referring to the preferred embodiment of FIG. 1, a distal spring assembly (2a), is coupled to a central spring assembly (2b) through a pair of spring mounts (6) secured by a plurality of fasteners (11). As also shown in the figure, the top portion of the distal spring assembly (2a) may include a spring mount (6) that can be further coupled with another spring assembly (2) or may be positioned to provide support internal to the spring (3). Again, referring to FIG. 1, the central spring assembly (2b) may be coupled with a proximal spring assembly (2c) through a pair of spring mounts (6) secured by a plurality of fasteners (11).

As further shown in FIG. 1, each spring assembly includes a support rod (4) positioned internally to the body of the spring (3) and inserted through the one or more spring mounts (6). In this preferred embodiment, a distal support rod (4a) may be secured to a spring mount (6) on the top portion of the distal spring assembly (2a) and further extend through the internal portion of the spring (2) and be coupled in series with a central support rod (4b), preferably through a coupler assembly (5). In this embodiment, the central support rod (4b) may be inserted through the paired and secured spring mounts (6) securing the distal spring assembly (2a) and central spring assembly (2b), and may further be coupled in series with a proximal support rod (4c), again preferably through a coupler assembly (5). The proximal support rod (4c) may be inserted through the paired and secured spring mounts (6) securing the central spring assembly (2b) and the proximal spring assembly (2c), and may further be coupled with a base (7), and preferably through a base coupler (9). A base coupler (9) of the invention may be selected from the group consisting of: a fitted coupler, a pin coupler, a twist coupler, a snap coupler, a quick release coupler, a slide coupler, a latch coupler, and a lock coupler. In an alternative embodiment, the support rod (4) of the invention, and in a preferred embodiment, the proximal support rod (4c), and may further be coupled with a ground spike (8) configured to secure the spring-actuated marketing display (1) in an upright position. In still further embodiments, the base coupler (9) of the invention can further include a ground spike (8) configured to secure the spring-actuated marketing display (1) in an upright position. In still further embodiment, the support rod (4) of the invention, and in a preferred embodiment, the proximal support rod (4c), and may further be coupled with a base (7), such as a weighted base configured to secure the spring-actuated marketing display (1) in an upright position.

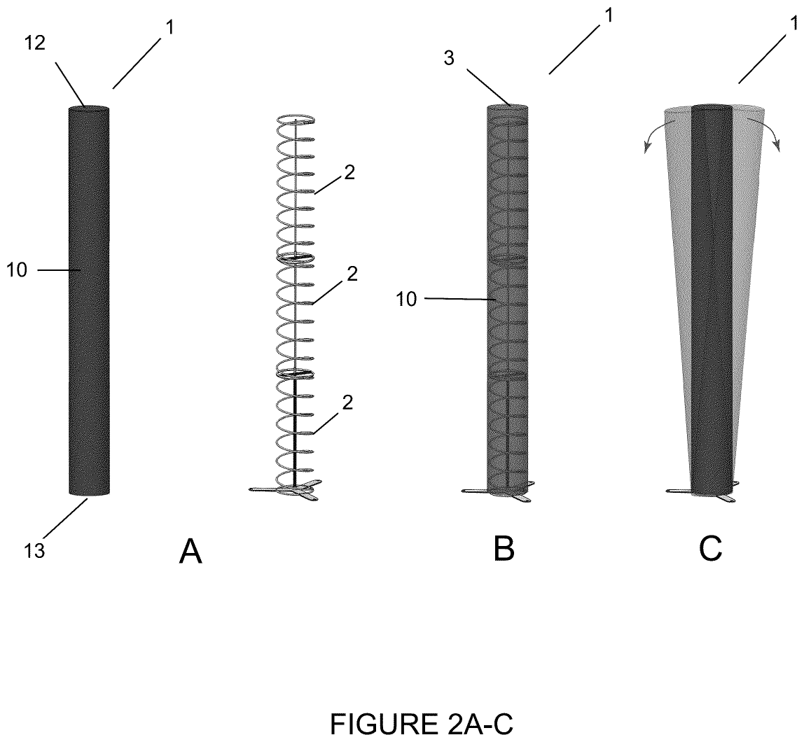

As further shown in FIG. 1, the support rods (4) of the invention can be tapered, such that the proximal support rod (4c) has less lateral flexibility, and therefore less lateral movement that the central support rod (4c), which in turn has less lateral flexibility, and therefore less lateral movement that the distal support rod (4c). As shown in FIG. 2A. in this embodiment, movement at the top, or distal portion of the display (1) will have the most lateral movement, with less lateral movement at positions more proximal to the base (7).

In a preferred embodiment, this sequential different in lateral movement can be achieved by having the support rods (4) taper, such that the proximal support rod (4c) is thicker and has less lateral flexibility, and therefore less lateral movement that the central support rod (4c), which in turn is thicker and has less lateral flexibility, and therefore less lateral movement that the distal support rod (4c) which is thinner and more flexible that the other support rods (4).

In one preferred embodiment, the distal, central and proximal support rods (4a,b,c) may secure the spring mounts (6) and their corresponding springs to a base (7) forming a linear series of spring assemblies (2) that can move in a lateral direction when an external force is applied, with the base (7) providing a weighted, or secured element to prevent the assembly from tipping over due to excessive lateral movement. In certain embodiments, the base (7) of the invention may include a weighted element, while alternative embodiments may include a base having a large radius, or a base that may be secured to the group, or other external surface, for example through one or more stakes.

As noted above, and shown in FIG. 1, the lateral movement of the spring-actuated marketing display (1) can be regulated through the rigidity of the supporting rods (4) of the invention. In one example, a rigid support rod (4) may allow little to no lateral movement of the one or more spring assemblies (2), while a tractable support rod (4) will allow greater lateral movement of the one or more spring assemblies (2).

In another embodiment, the support rods (4) of the invention can be tapered, such that each successive support rod (4) is sequentially thinner or more tractable that the proceeding tractable support rod (4), such that the terminal tractable support rod (4a) is more tapered than any other tractable support rod (4b,c) and therefor has the most lateral flexibility.

In certain embodiments, it may be desired to allow greater lateral movement at the distal portion of spring-actuated marketing display (1), and less or no lateral movement at the distal portion of the spring-actuated marketing display (1). As shown in FIG. 1, in one embodiment, the distal and central support rods (4a,b) may be made of a tractable material, such as fiberglass or plastic such that they are able to move laterally when an external force is applied to the marketing display (1). In this example, the proximal support rod (4c) may be formed from a rigid material, such as aluminum or other metals, such that lateral movement of the corresponding proximal spring assembly (2c) is decreased or prevented. In still further alternative, the invention may include a single support rod that can secure one or a plurality of spring assemblies (2) by being secured to a spring mount (6) as described herein. This unitary support rod (4) may further be formed of a single uniform material, which may be rigid, or tractable as herein described. In alternative embodiments, the support rod (4) of the invention may be a hybrid support rod (4) formed of a multiple material, which may include both rigid and tractable portions as herein described.

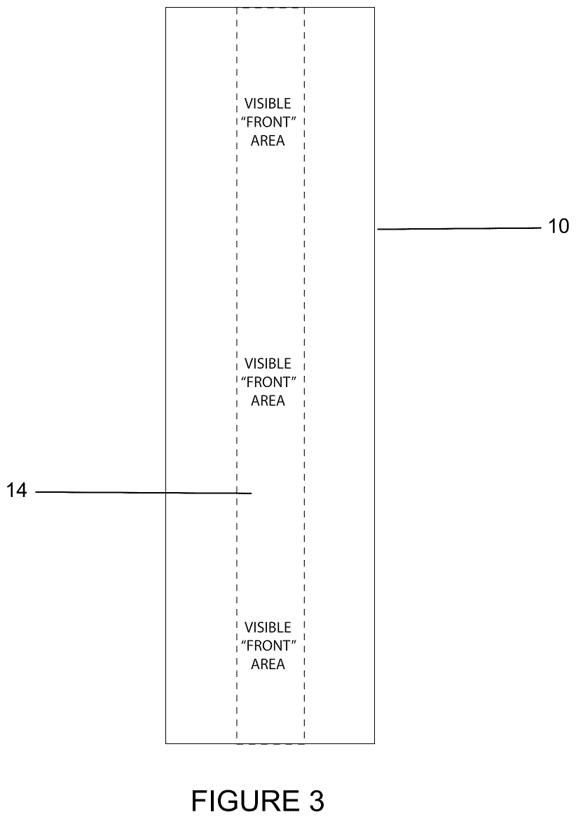

A spring-actuated marketing display (1) of the invention may include a display cover (10). In the embodiment shown in FIGS. 2-3, a display cover (10) of the invention may include a lightweight fabric cover, such as knitted polyester, which can be imprinted with a visual display, such as advertising images or text, and preferably at a display section (14) that may form the front visual portion of the display cover (10) when and positioned over one or more spring assemblies (2). In this preferred embodiment, display cover (10) of the invention includes a channel (13) through which one or more spring assemblies (2) can be inserted and an end cap (12) portion that may form the terminal edge of the display cover (10) that rests against the top of the one or more spring assemblies (2). In this embodiment, the lateral movement of the spring-actuated marketing display (1) can act as a visual attractant to consumers. In alternative embodiments, an air blower (not showing) can be configured to inject air into the display cover (10) which can contain one or more inflatable attractants that move in response to the blowing air, such as exemplary arms, legs or other extending and retracting extensions of the display cover.

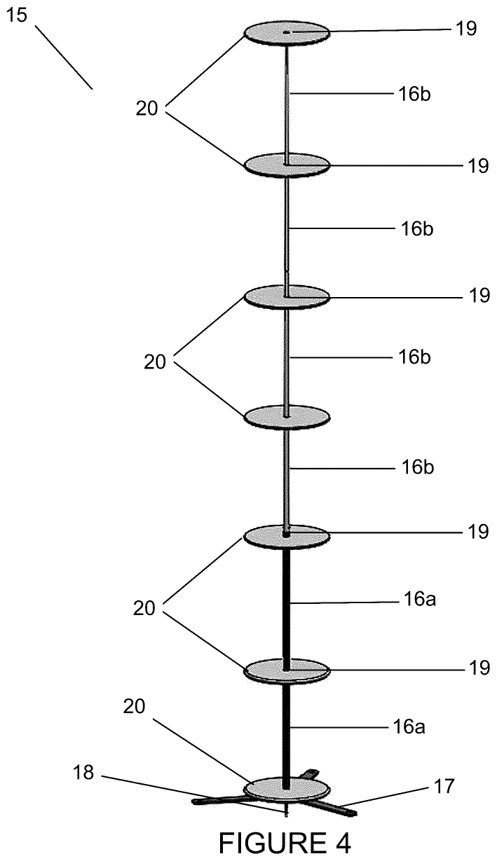

The present invention includes a tractable marketing display (15) that can exhibit lateral movement when an external force is applied to the display. In one embodiment the tractable marketing display (15) if the invention includes a support rod (4) configured to be positioned approximately vertically. As shown in the embodiment of FIG. 4, tractable marketing display (15) can include a plurality of coupled support rods (4a,b), which as described below can be rigid or tractable allowing controlled lateral movement along the vertical axis of the marketing display (15).

The tractable marketing display (15) of the invention can a base (17) configured to secure the support rod (4) in an approximately vertical positions and prevent it from tipping over due to excessive lateral movement. In a preferred embodiment, a base can include a weighted configured to secure the tractable marketing display (15) in an upright position. In alternative embodiments, the base may include a ground spike (18) configured to be secured in the ground and secure the tractable marketing display (15) in an upright position. In alternative embodiments, the ground spike (18) can be a separable components that is securable to a base (17) or a support rod (4), or an integral components of a base (17) or a support rod (4).

The tractable marketing display (15) of the invention can include a plurality of disk supports (20) can be positioned at spaced intervals along the support rod (4). Referring again to FIG. 4, the plurality of disk supports (20) can be coupled to the support rod through a disk coupler (19). In a preferred embodiment, the disk coupler (19) can include a support projection extending from the support rod (4) that can pass through an aperture on the disk support (20) and positioned to support the underside of the disk (20). In alternative embodiments, the disk coupler (19) can include a fitted coupler, a pin coupler, a twist coupler, a snap coupler, a quick release coupler, a slide coupler, a latch coupler, and a lock coupler.

The tractable marketing display (15) of the invention may include a display cover (10). In the embodiment shown in FIGS. 2-3, a display cover (10) of the invention may include a lightweight fabric cover, such as knitted polyester, which can be imprinted with a visual display, such as advertising images or text, and preferably at a display section (14) that may form the front visual portion of the display cover (10) when and positioned over the plurality of disk supports (20) which provide a framework for the shape of the display cover (10). In this preferred embodiment, display cover (10) of the invention includes a channel (13) through which one or more disk supports (20) can be inserted and an end cap (12) portion that may form the terminal edge of the display cover (10) that rests against the top of the most terminally positioned disk support (20). In this embodiment, the lateral movement of the tractable marketing display (15) can act as a visual attractant to consumers.

As noted above, and shown in FIG. 4, the lateral movement of the tractable marketing display (15) can be regulated through the rigidity of the corresponding supporting rods (16) of the invention. In one example, a rigid support rod (16) may allow little to no lateral movement of any section the tractable marketing display (15), while a tractable support rod (16) will allow greater lateral movement. In certain embodiments, it may be desired to allow greater lateral movement at the distal portion of tractable marketing display (15), and less or no lateral movement at the distal portion of the tractable marketing display (15). As shown in FIG. 4, in one embodiment, the tractable support rods (16b may be positions distal to a rigid support rod (16a) and may further be made of a tractable material, like as fiberglass or plastic such that they are able to move laterally when an external force is applied to the display (15). In this example, the rigid support rod (16a) may be formed from a rigid material, such as aluminum or other metals, such that lateral movement of the corresponding portion of the marketing display (15) is decreased or prevented. As further shown in FIG. 4, the support rods (16) of the invention can be tapered, such that each successive tractable support rod (16a) is sequentially thinner or more tractable that the proceeding tractable support rod (16a), such that the terminal tractable support rod (16a) is more tapered than any other tractable support rod (16a) and therefor has the most lateral flexibility.

All embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish a spring-actuated marketing display and the like. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in method-oriented terminology, each element of the claims corresponds to a device. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “supporting method and/or technique, and/or device.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The patent application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing a spring-actuated marketing display as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

1. A spring-actuated marketing display comprising:
a plurality of spring assemblies, each spring assembly comprising:
a spring;
at least one spring mount;
a support rod secured to said spring mount;
wherein each of said support rods are coupled forming a linear series of spring assemblies;
a base securing said support rods;
a display cover positioned over said plurality of spring assemblies.

2. The marketing display of claim 1, wherein said plurality of spring assemblies comprises:
a distal spring assembly;
one or more central spring assemblies; and
a proximal spring assembly.

3. The marketing display of claim 2, wherein said distal spring assembly is coupled with the central spring assembly, and a proximal spring assembly is coupled with the central spring assembly by securing the spring mounts of each assembly.

4. (canceled)

5. The marketing display of claim 1, wherein said support rods comprise:
a distal support rod;
one or more central support rods; and
a proximal support rod.

6. The marketing display of claim 5, wherein said distal support rod, and one or more central support rods are flexible and said proximal support rod is static.

7. The marketing display of claim 5, wherein said distal support rod, and one or more central support rods comprise fiberglass support rods and said proximal support rod comprises a metal support rod.

8. The marketing display of claim 5, wherein said distal support rod, and one or more central support rods comprise fiberglass support rods and said proximal support rod comprises a metal support rod.

9. The marketing display of claim 8, wherein said base coupler assembly is selected from the group consisting of: a fitted coupler, a pin coupler, a twist coupler, a snap coupler, a quick release coupler, a slide coupler, a latch coupler, and a lock coupler.

10. The marketing display of claim 5, wherein said support rods are coupled in series through a coupler assembly.

11. The marketing display of claim 10, wherein said coupler assembly comprises a coupler selected from the group consisting of: a fitted coupler, a pin coupler, a twist coupler, a snap coupler, a quick release coupler, a slide coupler, a latch coupler, and a lock coupler.

12. The marketing display of claim 1, wherein said base comprises a weighted base.

13-14. (canceled)

15. A marketing display comprising:
a spring assembly comprising:
a spring;
a spring mount
a support rod secured to said spring mount;
a base securing said support rod;
a display cover positioned over said spring assembly.

16-30. (canceled)

31. A tractable marketing display comprising:
a support rod;
a plurality of disk supports positioned along the length of said support rod;
a base securing said support rod;
a display cover positioned over said plurality of disk supports; and
wherein the terminal portion of the support rod is tractable allowing the rod to move laterally, and wherein the proximal portion of the support rod is static inhibiting lateral movement of the rod.

32. The display of claim 31, wherein said support rod comprises at least one rigid support rod coupled with at least one tractable support rod.

33. The display of claim 31, wherein said support rod comprises at least one rigid support rod coupled with a plurality of tractable support rods being coupled in series and wherein each tractable support rods is tapered as compared to the proceeding rod.

34. The marketing display of claim 31, wherein said tractable support rod comprise fiberglass support rods and said rigid support rod comprises a metal support rod metal.

35. The display of claim 31, further comprising a base securing said support rod.

36. The display of claim 31, further comprising a ground stake coupled with said support rod, or a ground stake coupled with said base.

37. The display of claim 36 wherein said ground stake is integral with said support rod, or said ground stake is integral with said base.

38. The display of claim 31, further comprising a plurality of disk couplers securing each of said disk supports to said support rod.

39-40. (canceled)
